(19) United States
(12) Patent Application Publication
(10) Pub. No.: US 2021/0390070 A1
(43) Pub. Date: Dec. 16, 2021

(54) UNIVERSAL INDUSTRIAL I/O INTERFACE BRIDGE

(71) Applicant: HEWLETT PACKARD ENTERPRISE DEVELOPMENT LP, Houston, TX (US)

(72) Inventors: Harvey Edward White, JR., Houston, TX (US); Aalap Tripathy, Houston, TX (US); Martin Foltin, Ft. Collins, CO (US); William Edward White, Ft. Collins, CO (US)

(21) Appl. No.: 16/903,286

(22) Filed: Jun. 16, 2020

(51) Int. Cl. G06F 13/40; G06F 13/42

(52) U.S. Cl. CPC G06F 13/4027; G06F 2213/0042; G06F 2213/0026; G06F 13/4282

(57) ABSTRACT

A universal industrial I/O interface bridge is provided. The universal industrial I/O interface bridge may be placed between a host and I/O interface cards to translate and manage electronic communications from these and other sources. Embodiments of the application may include (1) an improved hardware module, (2) an I/O discovery process to dynamically reprogram the universal industrial I/O interface bridge depending on the attached I/O card, (3) an abstraction process to illustrate the universal industrial I/O interface bridge and the physical I/O interfaces, (4) an alert plane within the universal industrial I/O interface bridge to respond to I/O alert pins, and (5) a secure distribution process for a firmware update of the universal industrial I/O interface bridge.

### DESCRIPTION OF RELATED ART

Internet of Things (IoT) devices are devices that have connectivity functionality and originate with various manufacturers and specifications. IoT devices may connect to computing devices and other IoT devices to transmit and receive data. As more IoT devices connect, the communication and connectivity between these devices becomes prohibitively difficult, causing many IoT devices to connect only with the same manufacturer.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of a computer system, in accordance with an embodiment of the application.

FIG. 2 illustrates an example of a computer system, in accordance with an embodiment of the application.

FIG. 3 illustrates an example of an industrial I/O interface bridge, a plurality of I/O cards, and sensors, in accordance with an embodiment of the application.

FIG. 4 illustrates an example computer system for I/O discovery, in accordance with an embodiment of the application.

FIG. 5 illustrates an example computer system for I/O discovery, in accordance with an embodiment of the application.

FIG. 6 illustrates an example computer system for I/O discovery, in accordance with an embodiment of the application.

FIG. 7 illustrates an example computer system for connection tunneling, in accordance with an embodiment of the application.

FIG. 8 illustrates an example computer system for alert support, in accordance with an embodiment of the application.

FIG. 9 illustrates an example computer system for implementing firmware updates, in accordance with an embodiment of the application.

FIG. 10 illustrates a computing component for providing a universal industrial I/O interface bridge, in accordance with embodiments of the application.

FIG. 11 is an example computing component that may be used to implement various features of embodiments described in the present disclosure.

The figures are not exhaustive and do not limit the present disclosure to the precise form disclosed.

### DETAILED DESCRIPTION

Internet of Things (IoT) devices may exchange data between other devices such as computing devices and/or other IoT devices. As used herein, a “device” refers to an article that is adapted for a particular purpose and/or multiple purposes. Examples of devices include sensors, computing devices, IoT enabled devices, industrial IoT (IIoT) enabled devices, etc., which may be included on a virtualized architecture and/or a non-virtualized architecture. As used herein, “IoT enabled devices” include devices embedded with electronics, software, sensors, actuators, and/or network connectivity which enable such devices to connect to a network and/or exchange data. As used herein, “IIoT” enabled devices refer to IoT enabled devices that are used in industrial applications, such as manufacturing or energy management for example. Examples of IoT enabled devices include sensors, vehicles, monitoring devices, devices enabling intelligent shopping systems, manufacturing devices, among other cyber-physical systems. A management server may manage the operation of multiple devices in an environment and/or rely on information from IIoT and/or IoT enabled sensors.

However, with increased connectivity of the management server comes increased communication issues. I/O expansion cards and software may be integrated with the system to improve collection, digitization, and operation on data, yet technical issues arise in interacting with various legacy systems. These legacy systems may utilize a large variety of industrial I/O protocols and legacy I/O cards (e.g., analog to digital, digital to analog, industrial Ethernet—TTE/TSN/ProfiNet, etc.), where different protocols are used between different devices in a distributed, expansive system. Accordingly, the connectively may be streamlined for IoT devices, as described herein, by using a universal industrial I/O interface bridge, such as a Field Programmable Gate Array (FPGA), programmed with a learning neural network accelerator logic. The universal industrial I/O interface bridge may be placed between a x86 host Converged Edge platform and I/O interface cards to translate and manage electronic communications from these and other sources.

Various features of the universal industrial I/O interface bridge are described herein, including (1) a hardware module that employs the universal industrial I/O interface bridge between the processor of the control unit (the host) and the I/O drivers and receivers (the I/O cards), (2) an I/O discovery process to dynamically reprogram the universal industrial I/O interface bridge depending on the attached I/O cards, (3) an abstraction process to illustrate the universal industrial I/O interface bridge and the physical I/O interfaces, (4) an alert plane within the universal industrial I/O interface bridge to respond to I/O alert pins, and (5) a secure distribution process for a firmware update of the universal industrial I/O interface bridge. Additional detail of at least these improvements is provided herein.

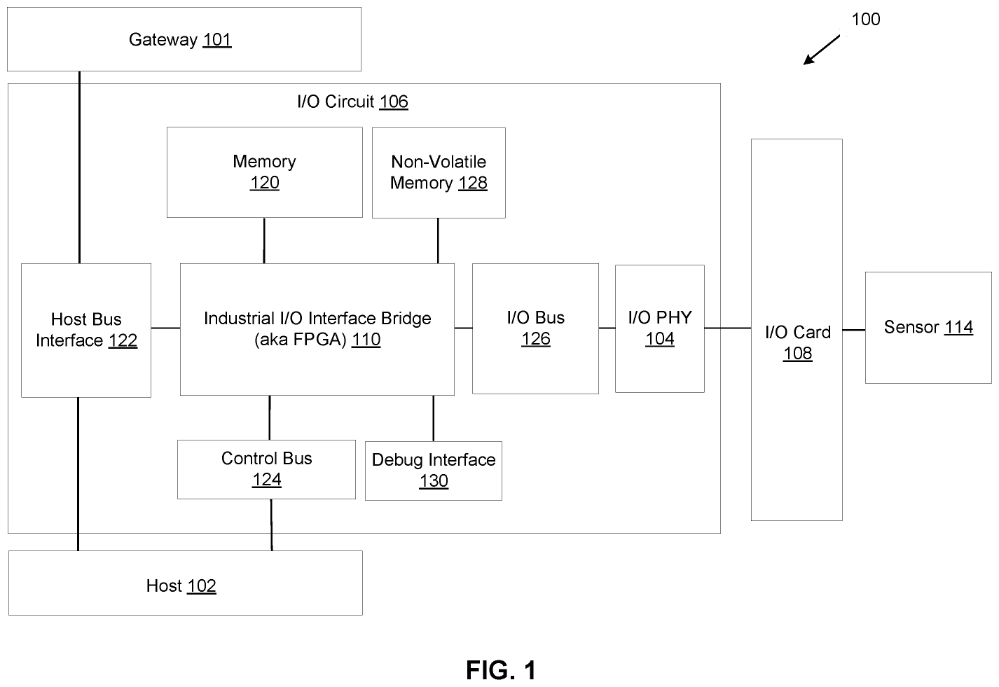

FIG. 1 illustrates an example of a computer system, in accordance with an embodiment of the application. Computer system 100 may include gateway 101, host 102, input/output (I/O) module 106, I/O cards 108, and sensors or actuators 114. For the sake of brevity, we will use the term “sensor” henceforth to refer to either a sensor or an actuator. Computer system 100 may include an field-programmable gate array (FPGA), complex programmable logic device (CPLD), or any other type of programmable hardware.

Gateway 101 may be a component that communicatively couples multiple devices, such as a computing device, a printer, a wireless computing device, a switch, IoT device, etc. with computer system 100. As used herein, the term “communicatively coupled” refers to a device being coupled directly, indirectly, and/or wirelessly to the gateway such that signals and/or data may be transmitted and/or received. For example, gateway 101 may be an intelligent gateway, a programmable logic controller, or similar components. As used herein, the term “intelligent gateway” refers to a device or application that serves as a connection point between intelligent devices. As used herein, the term “programmable logic controller” refers to an industrial computing device that has been adapted to work in harsh conditions to control manufacturing processes.

Host 102 may comprise a computer system based on an instruction set architecture, including x86 architecture. Computer system 100 may implement a gateway to host 102 and/or pass data directly to host 102. In some examples, host 102 may be implemented as local (PCIe or USB connected) host or remote (ethernet connected) host. In some examples, host 102 may be implemented as a hybrid model with some control local within virtual PLC and some in host 102.

I/O cards 108 may be an interface that allows sensor 114 to communicate with other components of computer system 100. I/O Card 108 may contain circuitry to help transport data from the sensor 114 to other components in the computer system 100. In some examples, I/O cards 108 may transport data from the sensor 114 to the gateway 101 through I/O circuit 106. In some examples, I/O cards 108 may comprise direct I/O, including general purpose input/output (GPIO), analog to digital (A-D), or digital to analog (D-A). In some examples, I/O cards 108 may comprise protocol I/O, including 4 to 20 milliamp (mA), Highway Addressable Remote Transducer (HART) transducer protocol, profiNet, or Ethernet for Control Automation Technology (EtherCAT). In some examples, I/O cards 108 may comprise third party I/O, including programmable logic controller (PLC) or programmable controller vendors that may implement a variety of communication protocols.

Sensors 114 may provide data to gateway 101, host 102, or I/O circuit 106 via I/O cards 108. In some examples, sensors 114 may be connected to one or more I/O cards 108. In various examples, computer system 100 may include a plurality of sensors, collectively referred to as sensor 114.

I/O circuit 106 may provide a path that data sent by a sensor travels to reach a set destination. I/O circuit 106 may connect gateway 101 to the I/O cards 108 which allows I/O cards 108 to communicate with gateway 101. In addition, I/O circuit 106 may allow I/O cards 108 to transmit data from sensor 114 to the gateway 101. Similarly, I/O circuit 106 may connect host 102 to the I/O cards 108 and allow the I/O cards to transmit data from sensor 114 to the host.

I/O circuit 106 may comprise various components, including host bus interface 122, control bus 124, I/O bus 126, memory 120, non-volatile memory 128, I/O PHY 104, debug interface 130, and industrial I/O interface bridge 110. In some examples, a CPU may not be included on I/O circuit 106 (e.g., implemented within gateway 101 or host 102) and data may be transmitted through I/O circuit 106 and scanned by industrial I/O interface bridge 110.

I/O circuit 106 further comprises host bus interface 122 and control bus 124. In some examples, I/O circuits is a PCI bus-compliant interface card adapted for coupling to the PCI bus of host 102, or adapted for coupling to a PXI (PCI eXtension) bus. Host bus interface 122 and control bus 124 may present a PCI or PXI interface. In other examples, I/O circuits is an interface card or a stand-alone module connected to the USB interface of host 102.

I/O bus 126 may present a RTSI (Real Time System Integration) bus for routing timing and trigger signals between I/O circuit and one or more other devices or cards, including gateway 101, host 102, or I/O cards 108.

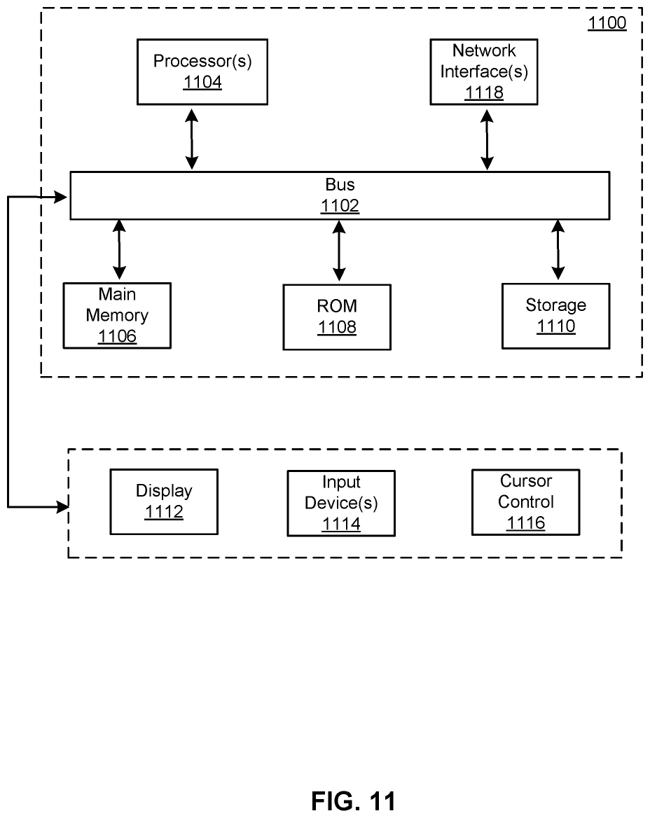

Memory 120 may store computer-executable instructions to be compiled into machine language for execution by a processor, as described in greater detail with FIG. 11. The computer-executable instructions may be provided in addition to a program being converted into a hardware implementation form in I/O circuit 106. Memory 120 may also buffer data passing through Industrial I/O Interface Bridge 110, and store intermediate results of data processing preformed in the Bridge.

Non-volatile memory 128 may employ a memristor, other resistive random-access memory (ReRAM), conductive bridging random-access memory (CBRAM), phase change random-access memory (PCRAM), Flash, or similar technologies. Non-volatile memory 128 may be operable to store the hardware description received from host 102 to enable execution of the hardware description prior to or during booting of the computer system. Non-volatile memory 128 may also store computer-executable instructions that are loaded to memory 120 for execution by a processor.

I/O PHY 104 may correspond with the physical connector ports between I/O circuit 106 and I/O cards 108. I/O PHY 104 may comprise one or more connectors for receiving signals. In some examples, I/O PHY 104 may present analog and/or digital connections for receiving or providing analog or digital signals. I/O PHY 104 can be a logical port, such as TCP/IP ports for common services such as 8080 for HTTP, or a virtual port in a virtual server network or other software-defined environment. I/O PHY 104 may include electronic circuitry that converts signal voltage levels between those of I/O Bus 126 and I/O Card 108. It may also provide conversion between voltage driven signaling and current driven signaling—such as, for example, the 4-20 mA current loop. I/O PHY 104 may also provide translation between a parallel communication bus and a serial interface bus.

Debug interface 130 may comprise a Joint Test Action Group (JTAG) standard interface that may be used for testing and maintenance of Industrial I/O Interface Bridge 110.

Industrial I/O interface bridge 110 may scan data from a sensor 114 to convert the data from a first format to a second format. Industrial I/O interface bridge 110 may comprise, for example, a Field Programmable Gate Array.

I/O circuit 106 may allow flexibility to connect to a wide range of I/O devices while also supporting traditional industrial busses, such as Fieldbus Protocol Types, Profibus, Profinet, EtherCAT, HART (e.g., over 4-20 mA loops, etc.), Modbus, and Modbus TCP. I/O circuit 106 may implement logic block libraries to house hardware implementation for popular functions (e.g., PID, DSP, and AI models, etc.). For example, these libraries may comprise Register Transfer Logic (RTL) or synthesized C/C++ representations of popular functions compiled to an FPGA bitstream.

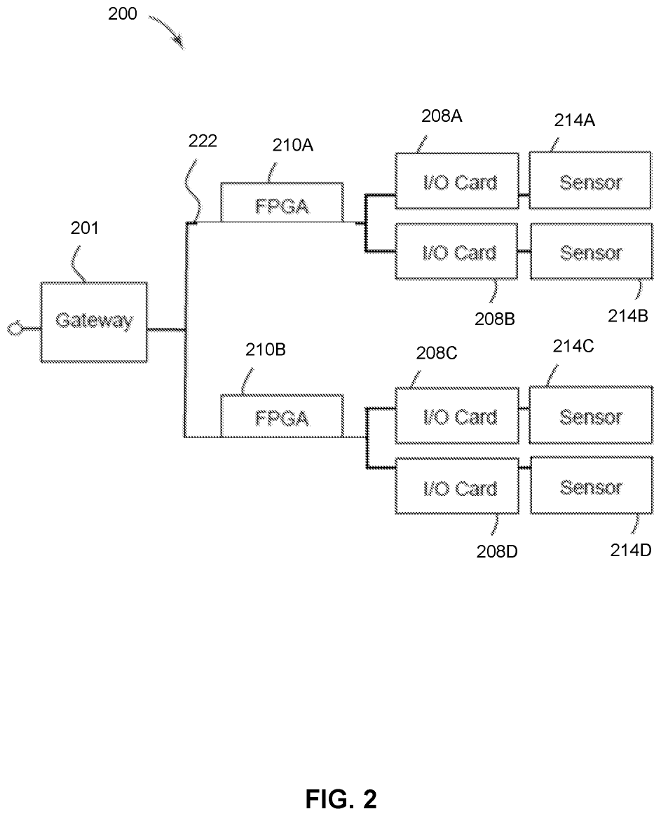

FIG. 2 illustrates another example of a computer system, in accordance with an embodiment of the application. Components of computer system 200 may correspond with several components of computer system 100 in FIG. 1. For example, gateway 101, industrial I/O interface bridge 110, I/O cards 108, and sensors 114 of FIG. 1 may correspond with gateway 201, industrial I/O interface bridge 210 (illustrated as a plurality of industrial I/O interface bridge 210A, 210B), I/O cards 208 (illustrated as a plurality of I/O cards 208A, 208B, 208C, 208D), and sensors 214 (illustrated as a plurality of sensors 214A, 214B, 214C, 214D) of FIG. 2, respectively. FIGS. 1 and 2 may illustrate similar computer systems with similar industrial I/O interface bridges, but shown in different formats to provide a more detailed description of embodiments described herein.

In some examples, computer system 200 may include a plurality of industrial I/O interface bridges 210. Each industrial I/O interface bridge 210 may be connected to a plurality of I/O Cards 208. Further, each I/O Card 208 may be connected to one or more sensors 214. That is, each industrial I/O interface bridge 210 may be connected to a plurality of legacy sensors through a plurality of I/O Cards. Each industrial I/O interface bridge 210 may be connected to a separate port of a host bus interface connected to the gateway 201.

For example, first sensor 214A may be connected to first I/O card 208A which is connected to first industrial I/O interface bridge 210A and second sensor 214B may be connected to second I/O card 208B which is connected to first industrial I/O interface bridge 210A. Similarly, third sensor 214C may be connected to third I/O card 208C which is connected to second industrial I/O interface bridge 210B and a fourth sensor 214D may be connected to fourth I/O card 208D which is connected to second industrial I/O interface bridge 210B. Further, first industrial I/O interface bridge 210A and second industrial I/O interface bridge 210B may both be connected to gateway 201 through host bus interface 222.

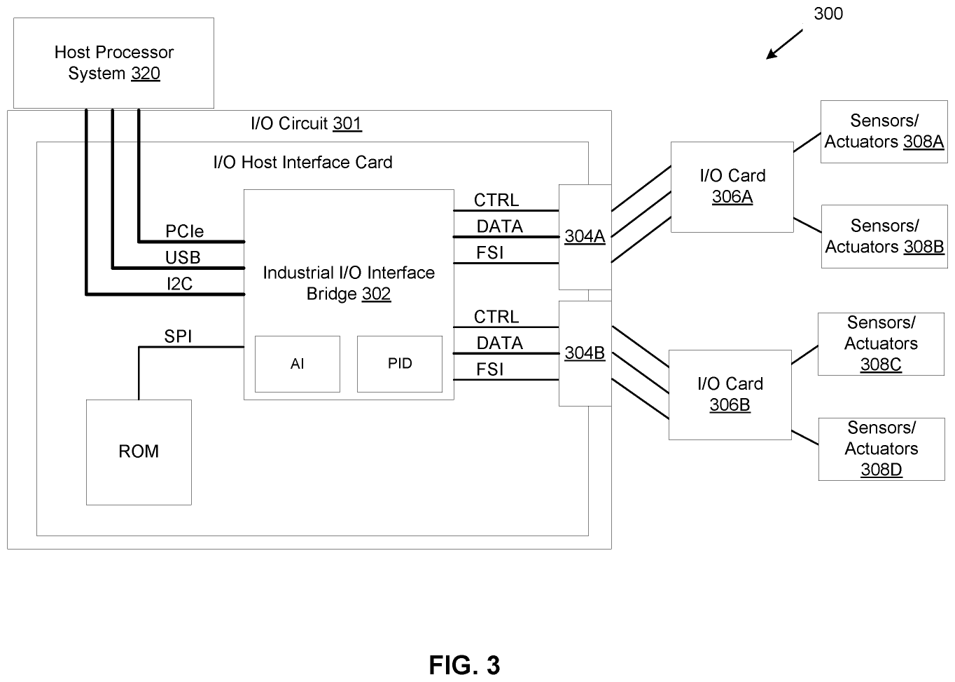

FIG. 3 illustrates an example of an industrial I/O interface bridge, a plurality of I/O cards, and sensors, in accordance with an embodiment of the application. Components of computer system 300 in FIG. 3 may correspond with several components of computer system 100 in FIG. 1. For example, I/O circuit 106, industrial I/O interface bridge 110, I/O PHY 104, I/O card 108, sensors 114, and host 102 of FIG. 1 may correspond with I/O circuit 301, industrial I/O interface bridge 302, I/O PHY 304 (illustrated as a plurality of I/O PHY 304A, 304B), I/O card 306 (illustrated as a plurality of I/O cards 306A, 306B), sensors 308 (illustrated as a plurality of sensors 308A, 308B, 308C, 308D), and host 320 of FIG. 3, respectively.

In some examples, industrial I/O interface bridge 302 may be implemented as a hardware module between host 320 (e.g., the processor, etc.) and I/O cards 306 (e.g., I/O drivers and receivers, etc.). As alluded to above, conventional systems may not implement an I/O interface bridge at all and require customized connections to enable electronic communications between host 320 and I/O cards 306. As described herein, industrial I/O interface bridge 302 is implemented to enable such electronic communications without independent customization of host 320 and I/O cards 306.

Due to the configurability of industrial I/O interface bridge 302, the interface logic can be changed by updating the code that is loaded in industrial I/O interface bridge 302. Updating the code can occur transparently to the user to abstract away the underlying physical interface. By using industrial I/O interface bridge 302, the signal pins between industrial I/O interface bridge 302 and I/O cards 306 are reconfigurable as to direction and function. One set of signals can be defined as a side-band Field Replaceable Unit (FRU) Service Interface (FSI) that can aid in detecting and identified the I/O card type.

Industrial I/O interface bridge 302 may be reconfigured based on one or more components in the Programmable Logic. For example, the physical I/O interface receivers and drivers (e.g., I/O PHY 304) may be turned on for specific I/O pins used by the discovered interface. They may be configured to use correct voltage levels and direction (e.g., input, output, or bi-directional, etc.).

The I/O controller hardware may be reconfigured. For example, a bitstream may be loaded that programs the configurable logic blocks to form logic gates and interconnect of the controller hardware. This controller may implement a specific I/O protocol. Industrial I/O interface bridge 302 can electronically communicate with I/O PHY 304 pins with the protocols. Among other things, the protocol determines which I/O pins are sending or receiving data, and at what times, achieving a proper hand-shake between industrial I/O interface bridge 302 and the connected I/O devices.

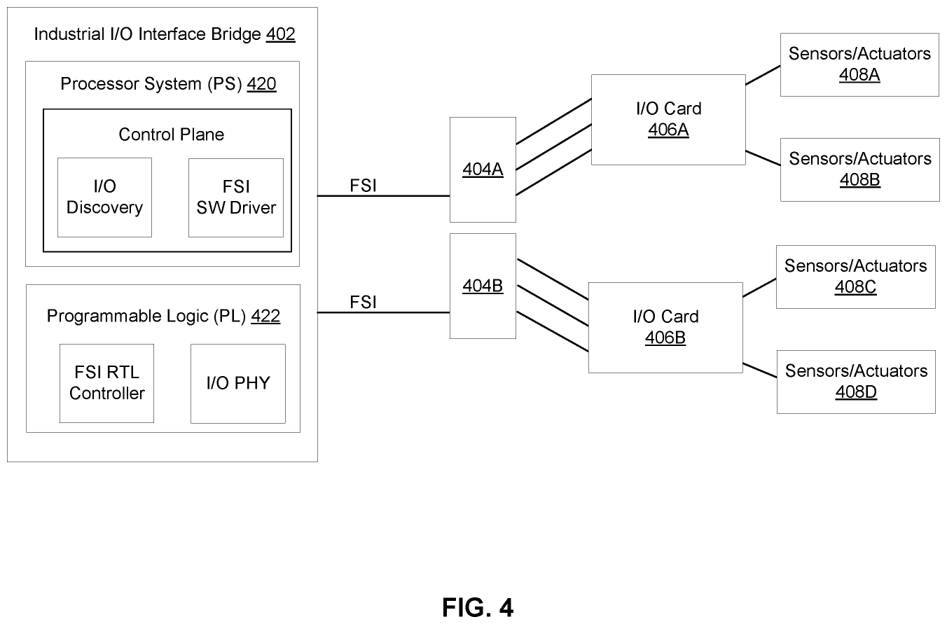

The specific I/O protocol may have multiple layers. For example, the lowest layer can use FSI, I2C, UART, or other communication standard. The next layer may include higher level functions, for example, Highway Addressable Remote Transducer (HART) or other protocols. Different I/O devices may communicate with different protocols, therefore the I/O discovery process can identify the protocol type used by the connected device, as described in further detail with FIGS. 4-6.

The controller hardware code can be incorporated with Register Transfer Logic (RTL) hardware description language or RTL I/O Controller (used interchangeably). The RTL can describe the state machines forming the controller. This representation may be synthesized to logic gates and interconnect, then sent to industrial I/O interface bridge 302 as a bitstream to implement these gates in configurable logic blocks. The bitstreams may be stored for different protocols in a non-volatile memory connected to industrial I/O interface bridge 302. After I/O discovery, the correct protocol bitstream may be loaded to industrial I/O interface bridge 302.

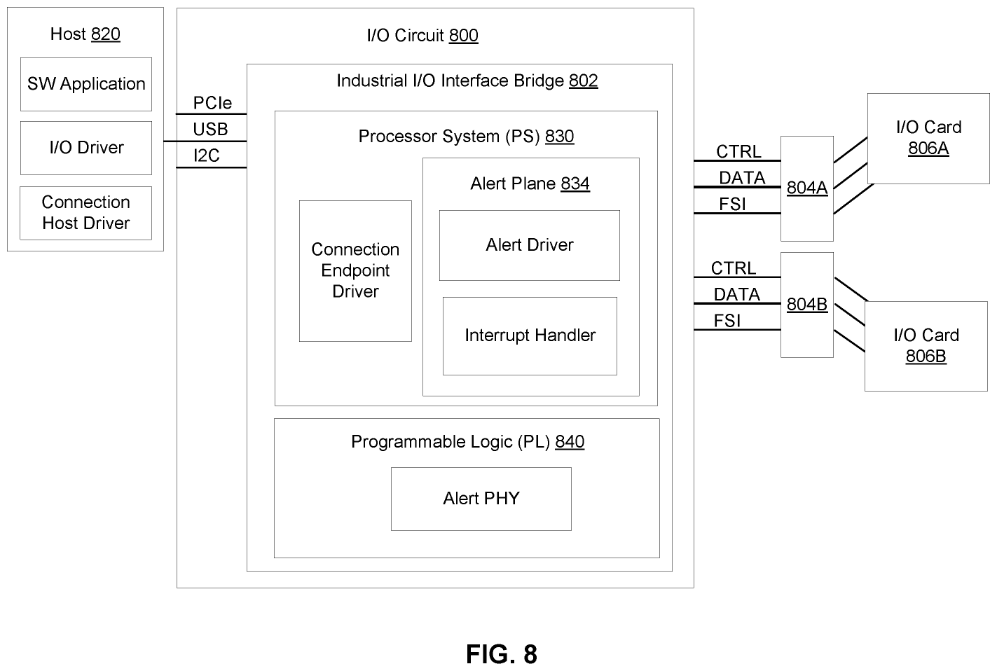

Components in the processor system may be reconfigured as well. For example, I/O software drivers may run on embedded processor cores under an operating system (e.g., Linux, etc.) kernel and interface to the I/O controller hardware, as described herein. The I/O alert software driver servicing I/O alert pins may be updated. For example, the I/O alert pins may trigger sending a low latency, high priority message from industrial I/O interface bridge 302 to host processor system 320, as described in further detail with FIG. 8.

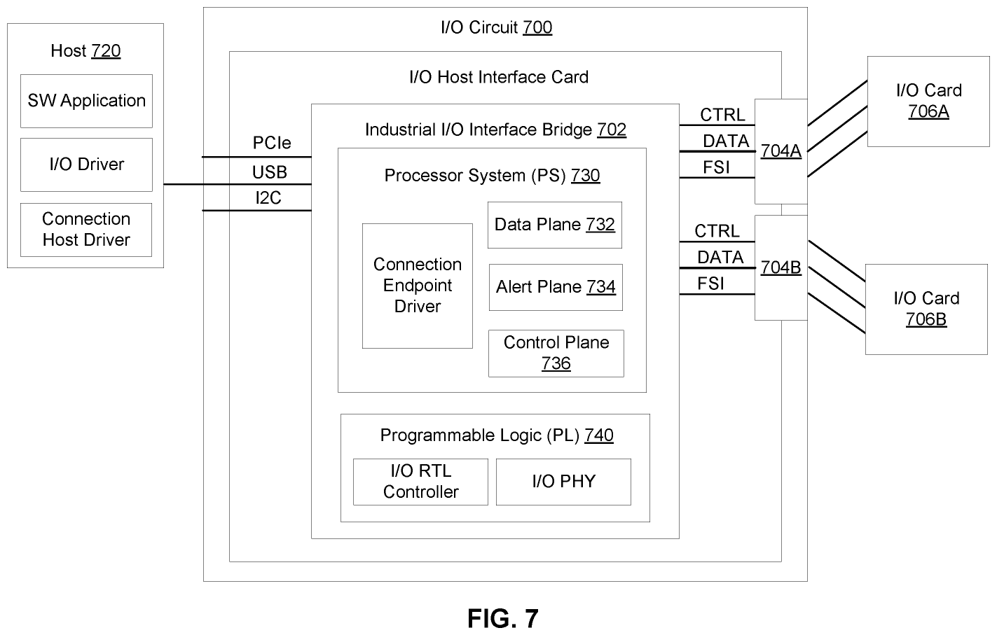

In some examples, the USB software driver that interfaces to industrial I/O interface bridge 302 USB hardware controller and connected through USB port to host processor system 320 may be updated. For example, this may correspond with a custom class USB driver interfacing to I/O software drivers helping to fan-out data from a single physical USB interface to one or more I/O controllers. A different class USB driver may be loaded for different I/O configurations and utilize I/O tunneling over USB, as described in further detail with FIG. 7.

A portion of I/O circuit 301 may be reconfigured based on output of two I/O device discovery mechanisms, including a FSI side-band interface driven method and an inventory method. In the first method, the FSI management interface (e.g., Field Replaceable Unit Service Interface or “FRU SI”) is polled periodically to monitor what I/O device types are attached. The FPGA may be reconfigured when a new device is discovered. The FSI management interface may be standardized across many I/O devices, even though these I/O devices can have different data I/O interfaces. On the FPGA, the FSI may be configured at power-up and remain on constantly. During FPGA reconfiguration, the FSI may not be touched, but the data I/O interfaces may be reconfigured. For I/O devices not supporting the FSI, the second method may be used, including an inventory based I/O discovery method. In this method, the FPGA is iteratively reconfigured trying sequentially different interface and protocol types until a successful communication with the I/O device is established. The interface types are loaded from an inventory in an intelligent order, to avoid overdriving I/O interface pins. For example, the low voltage interfaces (such as, 1.8V) may be tried first, which may be followed with higher voltage (3.3V, 5V, and so on) interfaces. The I/O pins may be configured first to test if the connected signal is a receiving, driving, or a multi-driven net. With either of the two I/O device discovery mechanisms, the FPGA may be reconfigured at power-up time and can be reconfigured again if high error rates or loss of communication is detected on I/O interfaces, which may be indicative of I/O device change.

FIG. 4 illustrates an example computer system for I/O discovery, in accordance with an embodiment of the application. Components of computer system 400 in FIG. 4 may correspond with several components of computer system 100 in FIG. 1. For example, industrial I/O interface bridge 110, I/O PHY 104, I/O card 108, and sensors 114 of FIG. 1 may correspond with industrial I/O interface bridge 402, I/O PHY 404 (illustrated as a plurality of I/O PHY 404A, 404B), I/O card 406 (illustrated as a plurality of I/O cards 406A, 406B), and sensors 408 (illustrated as a plurality of sensors 408A, 408B, 408C, 408D) of FIG. 4, respectively.

To identify industrial I/O cards 406 attached to industrial I/O interface bridge 402, the system may implement an I/O discovery method that involves polling I/O cards 406 for their identity. As alluded to above, conventional systems may not implement an I/O discovery method and require independent identification of I/O cards 406, if such electronic communications with various types of I/O cards are permitted at all. As described herein, industrial I/O interface bridge 402 is implemented to enable such an I/O discovery of I/O cards 406 to eliminate need for manual intervention during provisioning of I/O devices, simplify onboarding of I/O devices in an existing industrial lines as they migrate to new advanced back-end compute infrastructures, and enable deployment of new infrastructures as a service, scaling to large number of I/O devices.

In some examples, an interface may be implemented to implement the I/O discovery process of I/O cards. At boot time, drivers, hardware controller, and physical I/O block may be loaded for a Field Replaceable Unit Service Interface (FSI). The FSI may be used by one or more I/O cards 406 for their management.

In some examples, the I/O discovery process may dynamically reprogram industrial I/O interface bridge 402 depending on the attached I/O card 406. In some examples, the I/O discovery process can help to dynamically reprogram industrial I/O interface bridge 402 by periodically monitoring the I/O card's side-band Field Replaceable Unit (FRU) Service Interface (FSI) port for I/O Data interface type.

The I/O discovery process may be implemented by a software program running on a processor system interfaced to hardware blocks implemented in a programmable logic. Industrial I/O interface bridge 402 may include a system on a chip consisting of a processor system 420 and programmable logic 422. Processor system 420 may run an embedded operating system (e.g., Linux). Programmable logic 422 may be programmed by a bitstream generated by synthesis of a Register Transfer Logic (RTL) representation of hardware blocks.

The discovery process may poll for new cards at regular intervals. During the I/O discovery process, the card information may be read via the FSI interface. The discovery process utilizes an FSI interface, FSI RTL Controller of programmable logic 422, and FSI SW Driver of processor system 420.

When a new I/O card is discovered, a bitstream with the hardware controller and I/O pin assignments for that card may be loaded from a NAND Flash repository into Programmable Logic (PL) 422. In some examples, device tree overlays may be employed to unload the old card drivers and load new drivers. This enables running an operating system (e.g., Linux) on industrial I/O interface bridge 402 to service other cards with zero interruption.

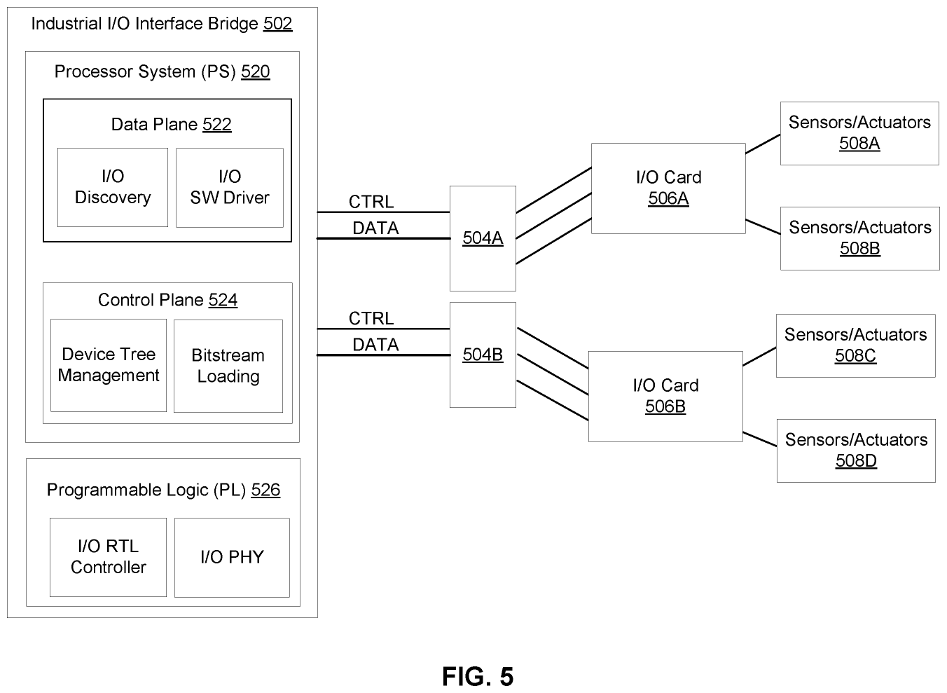

FIG. 5 illustrates an example computer system for I/O discovery, in accordance with an embodiment of the application. Components of computer system 500 in FIG. 5 may correspond with several components of computer system 100 in FIG. 1. For example, industrial I/O interface bridge 110, I/O PHY 104, I/O card 108, and sensors 114 of FIG. 1 may correspond with industrial I/O interface bridge 502, I/O PHY 504, I/O card 506, and sensors 508 of FIG. 5, respectively. Processor system 520 and programmable logic 526 of FIG. 5 may correspond with processor system 420 and programmable logic 422 of FIG. 4, respectively.

When I/O cards 506 do not support an FSI, an inventory method may be implemented. In this method, the system may iteratively try different interface and protocol types in an intelligent order to avoid overdriving I/O card interface pins. The discovery process may correspond with an inventory-based discovery process. For example, the discovery process may poll for new cards at regular intervals. In comparison with the discovery process of FIG. 4, which utilizes an FSI interface, FSI RTL Controller of programmable logic 422, and FSI SW Driver of processor system 420, the discovery process of FIG. 5 utilizes a data interface, the I/O RTL Controller of programmable logic 526, and I/O SW Driver of processor system 520. For cards without the FSI interface or port, the system may sequentially try interface protocols from an inventory. The I/O interfaces may be discovered by trying sequentially different protocols in an intelligent order to avoid over-driving the I/O ports.

Once the I/O card identity is determined, new I/O controller bitstream and software drivers may be loaded for the new I/O interface. Physical I/O pins may also be configured to correctly interact with this interface. In some examples, a device tree overlay method may be implemented to swap software drivers without affecting the operating system running on industrial I/O interface bridge 502.

FIGS. 4 and 5 may describe similar computer systems for implementing various embodiments of the discovery process. For example, FIG. 4 illustrates an example computer system for implementing an I/O device discovery method driven by the FSI and illustrates the FSI interface between industrial I/O interface bridge 402 and I/O PHY 404, FSI RTL Controller within programmable logic 422 and FSI SW Driver residing in the Control Plane. FIG. 5 illustrates an example computer system for implementing an I/O device discovery method driven by an inventory-based method. The data interface may exist between industrial I/O interface bridge 502 and I/O PHY 504, the I/O RTL controller within programmable logic 526, and the I/O SW Driver residing in the Data Plane. The inventory based method can try sequentially different protocols and interface types for this data interface and may load a new bitstream in every iteration of the sequential discovery process.

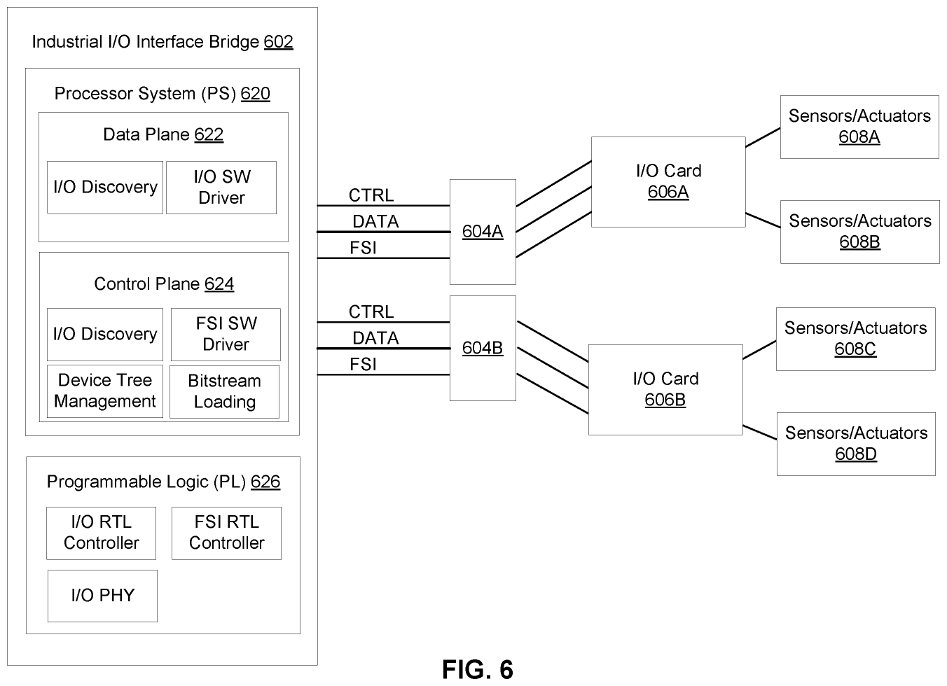

FIG. 6 illustrates an example computer system for I/O discovery, in accordance with an embodiment of the application. Components of computer system 600 in FIG. 6 may correspond with several components of computer system 100 in FIG. 1. For example, industrial I/O interface bridge 110, I/O PHY 104, I/O card 108, and sensors 114 of FIG. 1 may correspond with industrial I/O interface bridge 602, I/O PHY 604, I/O card 606, and sensors 608 of FIG. 6, respectively. Processor system 620, data plane 622, control plane 624, and programmable logic 626 of FIG. 6 may correspond with processor system 520, data plane 522, control plane 524, and programmable logic 526 of FIG. 5, respectively.

FIG. 6 may illustrate a combined computer system of FIGS. 4 and 5. Each of FIGS. 4, 5, and 6 have been simplified to not obscure features of these embodiments. For example, FIGS. 4 and 5 only show the interfaces and components involved in the I/O card discovery. Once the card is discovered, the bitstream may be loaded, and the software drivers may be loaded by the device tree overlay method. This may be common for both discovery methods, and is included in FIG. 6, with bitstream loading and device tree management, illustrated with control plane 524 of processor system 520, similarly illustrated with FIG. 6 within processor system 620.

FIG. 7 illustrates an example computer system for connection tunneling, in accordance with an embodiment of the application. Components of computer system 700 in FIG. 7 may correspond with several components of computer system 100 in FIG. 1. For example, I/O circuit 106, industrial I/O interface bridge 110, I/O PHY 104, I/O card 108, sensors 114, and host 102 of FIG. 1 may correspond with I/O circuit 700, industrial I/O interface bridge 702, I/O PHY 704, I/O card 706, and host 720 of FIG. 7, respectively. Processor system 730 and programmable logic 740 of FIG. 7 may correspond with processor system 420 and programmable logic 422 of FIG. 4, respectively.

In some examples, the abstraction process for connection tunneling may be embodied in software running on host 720 to operate as if I/O cards 706 are directly connected. This may help abstract industrial I/O interface bridge 702 and physical I/O interfaces.

As alluded to above, conventional systems may require customization at host 720 to accept new I/O cards 706. As described herein, industrial I/O interface bridge 702 is implemented to enable communicative coupling between I/O cards 706 and host 720 because industrial I/O interface bridge 702 can convert any communications on behalf of host 720, thus removing the need to modify an industrial software application running on host 720 to accept a different communication protocol.

The I/O card protocol traffic may be tunneled between host 720 and industrial I/O interface bridge 702 over USB or PCIe standard host interfaces using a scheme for modification of host device drivers. The scheme may redirect I/O traffic through the USB connection using a custom USB gadget class driver.

In some examples, host 720 may not be modified for implementing the abstraction process. For example, host 720 may transmit electronic data packets via modified I/O drivers, and the I/O drivers transmit electronic data packets to custom USB gadget host driver loaded by I/O discovery. The modified I/O drivers combined with the USB gadget class driver may be loaded automatically by the I/O discovery process discussed herein. In this process, the correct I/O and USB drivers may be loaded on industrial I/O interface bridge 702, which triggers loading of the corresponding USB driver on host 720. The USB and industrial I/O interface bridge 702 are thus abstracted from the host software application and the I/O interfaces are presented to the application as if they were local on the host.

On the industrial I/O interface bridge 702 side, the USB traffic may be routed to the corresponding I/O device driver and hardware controller programmed by the I/O card discovery mechanism described herein. Industrial I/O interface bridge 702 can be transparent to the application running on host 720 and allow application portability between different platforms.

In some examples, the abstraction process may support industrial alerts at low latency, as described in more detail with FIG. 8. The alert plane implemented by processor system 730 may comprise a hardware interrupt handler and alert firmware driver to handle electronic communications.

I/O circuit 700 can serve as a tunnel between the operations technology (OT) I/O interfaces and the information technology (IT) interfaces. This eliminates need to equip the host 720 with various kinds of industrial I/O interfaces and makes it easier to deploy in the OT domain the industry standard, securely managed, cost and performance optimized hosts and host infrastructures that are common in the IT domain. In some examples, the tunneling of industrial I/O traffic may pass through the USB IT interface. In other, latency and throughput sensitive examples, the tunneling of industrial I/O traffic may pass through the PCIe IT interface. There is no need to modify an industrial software application running on host 720.

FIG. 8 illustrates an example computer system for alert support, in accordance with an embodiment of the application. Components of I/O circuit 800 in FIG. 8 may correspond with several components of computer system 100 in FIG. 1. For example, industrial I/O interface bridge 110, I/O PHY 104, I/O card 108, and sensors 114 of FIG. 1 may correspond with industrial I/O interface bridge 802, I/O PHY 804, I/O card 806 of FIG. 8, respectively.

I/O circuit 800 comprises industrial I/O interface bridge 802 with processor system 830 and programmable logic 840. Processor system 830 comprises at least alert plane 834 within industrial I/O interface bridge 802 to respond to I/O alert pins. Alert plane 834 may be separate from data plane 732 and control plane 736 as illustrated in FIG. 7. In programmable logic 840, alert plane 834 may consist of dedicated I/O pins connected to industrial I/O card alert pins, and an interrupt controller attached to processor system 830. Alert plane 834 may be implemented within an embedded kernel module (e.g., Linux, etc.) attached to industrial I/O interface bridge 802 hardware interrupt handler programmed to respond to I/O alert pins.

In some examples, alert plane 834 enables handling in hardware of I/O alerts at low latency and concurrently with I/O data. Any interrupt alert messages from alert plane 834 may be provided to the USB host interface traffic at high priority using USB Interrupt data transfer type. Alert plane 834 may trigger an alert code that transmits a high priority alert message to host 820 (e.g., over-pressure, under-pressure, over-temperature, etc.) at low latency.

As alluded to above, conventional systems may need separate (side-band) signals to transmit alerts to the host 820, or use specialized protocols that are not common in the information Technology (IT) domain, requiring modifications of the host. As described herein, alert plane 834 is implemented to enable transmitting alerts together with data through the commonly used IT interfaces, such as USB or PCIe, while achieving low alert latency required by industrial systems.

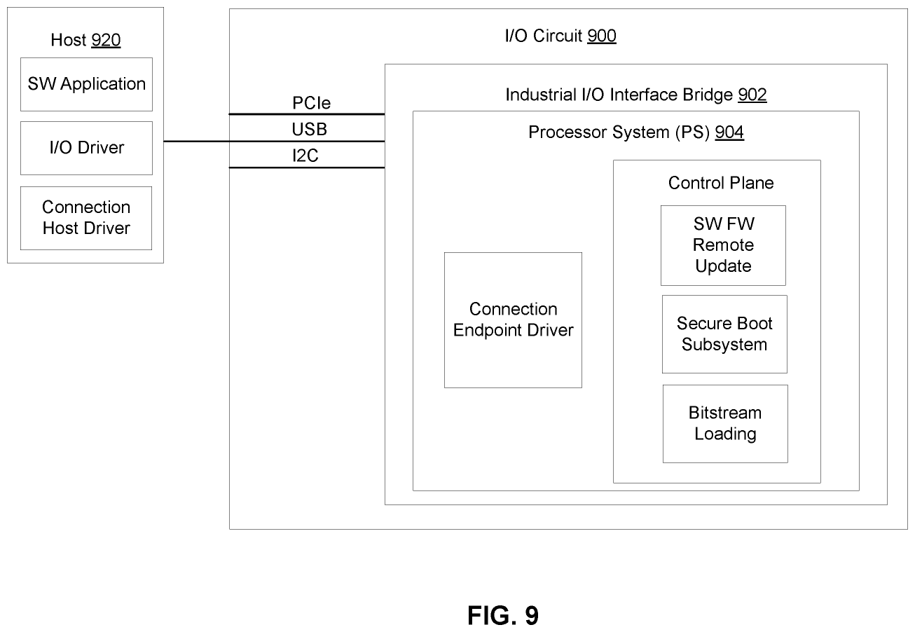

FIG. 9 illustrates an example computer system for implementing firmware updates, in accordance with an embodiment of the application. Components of I/O circuit 900 in FIG. 9 may correspond with several components of computer system 100 in FIG. 1. For example, industrial I/O interface bridge 110 and host 102 of FIG. 1 may correspond with industrial I/O interface bridge 902 and host 920 of FIG. 9, respectively.

I/O circuit 900 may implement a secure distribution process for a firmware update of industrial I/O interface bridge 902, rather than relying on manual or one-by-one updates to firmware throughout the system. This process may be triggered when new I/O card types are added to a bridge repository, and new sensor signatures are added for anomaly detection. Processor system 904 may receive new encrypted and/or digitally signed firmware and a programmable logic subsystem bitstream. Sensor signatures may also be received. The data may be received via USB or other connection methods described throughout the disclosure.

The digitally signed firmware and bitstream may be validated at industrial I/O interface bridge 902 for correctness (e.g., in comparison with a format dictionary or protocol) before storing in the NAND flash repository. In some examples, the secure distribution process may work in concert with a secure boot process for processor system 904. The firmware can be authenticated and decrypted using keys stored on a secure root of trust hardware module. The secure boot subsystem can use the silicon root of trust and support signature checking and decryption.

In some examples, a new set of device drivers running on host 920 may enable support of I/O circuit 900. The drivers may provide electronic instructions for transmitting data, control, and/or alerting under node-red based software platform. In some examples, existing cloud connectors and data containers implemented by host 920 can receive and transmit data from industrial I/O interface bridge 902 without changes.

Sensor monitoring and in-line sensor data monitoring may be implemented. The sensor monitoring may involve measuring threshold and/or rate of change associated with sensors or I/O cards, and comparing against sensor signatures loaded during firmware update process. In some examples, artificial intelligence (AI) time series analysis may be employed for sensor anomaly detection, with AI models loaded during firmware update process. Software code running on processor system 904 can monitor industrial I/O data stream for threshold and rate of change and generate an alert if these are inconsistent with prerecorded sensor signatures. In some examples, AI time series analysis can be employed to detect more subtle anomalies, using hardware acceleration on industrial I/O interface bridge 902 to operate in real time to help keep up with the data ingestion speed. This may involve running inference with stacked auto-encoder models, long-short term memory (LSTM) recurrent neural network (RNN) models, convolutional neural network (CNN) models, hierarchical temporal memory models, or other time series analysis models, accelerated in I/O interface bridge Programmable Logic.

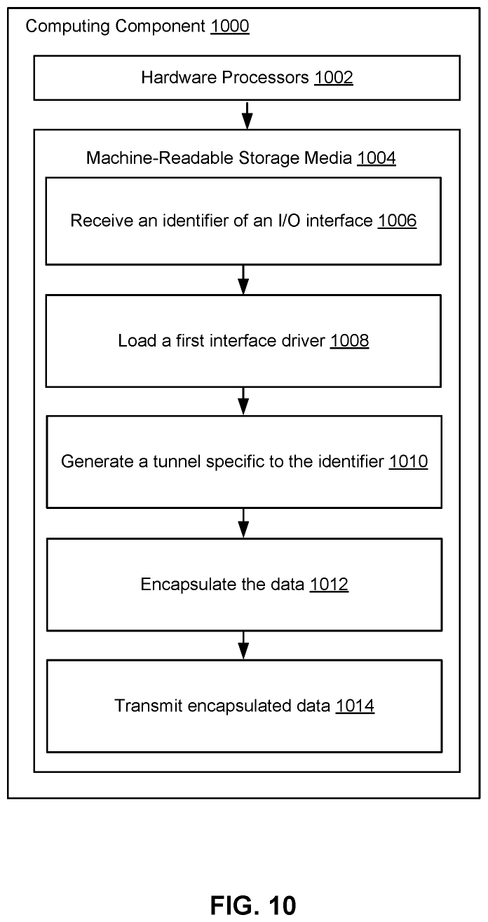

FIG. 10 illustrates a computing component for providing a universal industrial I/O interface bridge, in accordance with embodiments of the application. Computing component 1000 may be, for example, a server computer, a controller, or any other similar computing component capable of processing data. In the example implementation of FIG. 10, the computing component 1000 includes a hardware processor 1002, and machine-readable storage medium 1004. In some embodiments, computing component 1000 may be an embodiment of a system corresponding with computer system 100 of FIG. 1.

Hardware processor 1002 may be one or more central processing units (CPUs), semiconductor-based microprocessors, and/or other hardware devices suitable for retrieval and execution of instructions stored in machine-readable storage medium 1004. Hardware processor 1002 may fetch, decode, and execute instructions, such as instructions 1006-1014, to control processes or operations for optimizing the system during run-time. As an alternative or in addition to retrieving and executing instructions, hardware processor 1002 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1004, may be any electronic, magnetic, optical, or other physical storage device that contains or stores executable instructions. Thus, machine-readable storage medium 1004 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 1004 may be a non-transitory storage medium, where the term “non-transitory” does not encompass transitory propagating signals. As described in detail below, machine-readable storage medium 1004 may be encoded with executable instructions, for example, instructions 1006-1014.

Hardware processor 1002 may execute instruction 1006 to receive an identifier of an I/O interface. For example, the identifier may be associated with an I/O card communicatively coupled with the industrial I/O interface bridge. The industrial I/O interface bridge may comprise a processor system and a programmable logic.

Hardware processor 1002 may execute instruction 1008 to load a first interface driver. For example, the first interface driver of the processor system may be loaded. The first interface driver may be associated with the identifier. Prior to loading the first interface driver of the processor system, hardware processor 1002 may execute an instruction to reprogram the programmable logic based on the identifier.

Hardware processor 1002 may execute instruction 1010 to generate a tunnel specific to the identifier. For example, the tunnel specific to the identifier may be generated between the industrial I/O interface bridge and a host computing system or gateway. The tunnel may utilize the first interface driver of the processor system and a corresponding driver at the host computer system or gateway.

Hardware processor 1002 may execute instruction 1012 to encapsulate the data.

Hardware processor 1002 may execute instruction 1006 to transmit the encapsulated data. For example, the encapsulated data may be transmitted from a sensor or an actuator to the host computing system or gateway. In another example, the encapsulated data may be transmitted from the host computing system or gateway to the sensor or the actuator. The encapsulated data may be transmitted via the tunnel between the industrial I/O interface bridge and host computing system or gateway. The encapsulated data may be transmitted from the sensor or the actuator, or encapsulated data may be transmitted to the sensor or the actuator.

FIG. 11 is an example computing component that may be used to implement various features of embodiments described in the present disclosure. FIG. 11 depicts a block diagram of an example computer system 1100 in which various of the embodiments described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a read only memory (ROM) 1108 or other static storage device coupled to bus 1102 for storing static information and instructions for processor 1104. A storage device 1110, such as a solid state disk (SSD), magnetic disk, optical disk, or USB thumb drive (Flash drive), etc., is provided and coupled to bus 1102 for storing information and instructions.

The computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some embodiments, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, bitstreams, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

The computer system 1100 also includes communication interface 1118 coupled to bus 1102. Communication interface 1118 provides a two-way data communication coupling to one or more network links that are connected to one or more local networks. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN (or WAN component to communicate with a WAN). Wireless links may also be implemented. In any such implementation, communication interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1118, which carry the digital data to and from computer system 1100, are example forms of transmission media.

The computer system 1100 can send messages and receive data, including program code, through the network(s), network link and communication interface 1118. In the Internet example, a server might transmit a requested code for an application program through the Internet, the ISP, the local network and the communication interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. An industrial (input/output) I/O interface bridge comprising:
a processor system; and
a programmable logic, wherein the processor system and the programmable logic are collectively configured to:
receive an identifier of an I/O interface, wherein the identifier is associated with an I/O card communicatively coupled with the industrial I/O interface bridge;
load a first interface driver of the processor system, wherein the first interface driver is associated with the identifier;
generate a tunnel specific to the identifier between the industrial I/O interface bridge and a host computing system or gateway, wherein the tunnel utilizes the first interface driver of the processor system and a corresponding driver at the host computer system or gateway;
encapsulate data; and
transmit the encapsulated data from a sensor or an actuator to the host computing system or gateway, or vice versa from the host computing system or gateway to the sensor or the actuator, wherein the encapsulated data is transmitted via the tunnel between the industrial I/O interface bridge and host computing system or gateway, and wherein the encapsulated data is transmitted from or to the sensor or the actuator.

2. The industrial I/O interface bridge of claim 1, wherein the first interface driver is associated with a USB driver.

3. The industrial I/O interface bridge of claim 1, wherein the first interface driver is associated with a PCIe driver.

4. The industrial I/O interface bridge of claim 1, wherein the processor system is a software implementation and the programmable logic is a hardware implementation, and wherein the processor system and the programmable logic are altered in combination to accept the I/O card transparently from a user.

5. The industrial I/O interface bridge of claim 1, wherein the processor system and the programmable logic are collectively configured to:
prior to loading the first interface driver of the processor system, reprogram the programmable logic based on the identifier.

6. A computer-implemented method comprising:
receiving, by an industrial I/O interface bridge, an identifier of an I/O interface, wherein the identifier is associated with an I/O card communicatively coupled with the industrial I/O interface bridge;
loading, by the industrial I/O interface bridge, a first interface driver of a processor system, wherein the first interface driver is associated with the identifier;
generating, by the industrial I/O interface bridge, a tunnel specific to the identifier between the industrial I/O interface bridge and a host computing system or gateway, wherein the tunnel utilizes the first interface driver of the processor system and a corresponding driver at the host computer system or gateway;
encapsulating data; and
transmitting, by the industrial I/O interface bridge, the encapsulated data from a sensor or an actuator to the host computing system or gateway, or vice versa from the host computing system or gateway to the sensor or the actuator, wherein the encapsulated data is transmitted via the tunnel between the industrial I/O interface bridge and host computing system or gateway, and wherein the encapsulated data is transmitted from or to the sensor or the actuator.

7. The computer-implemented method of claim 6 wherein the first interface driver is associated with a USB driver.

8. The computer-implemented method of claim 6, wherein the first interface driver is associated with a PCIe driver.

9. The computer-implemented method of claim 6, wherein the processor system is a software implementation and programmable logic of the industrial I/O interface bridge is a hardware implementation, and wherein the processor system and the programmable logic are altered in combination to accept the I/O card transparently from a user.

10. The computer-implemented method of claim 6, further comprising:
prior to loading the first interface driver of the processor system, reprogramming programmable logic based on the identifier.

11. A non-transitory computer-readable storage medium storing a plurality of instructions executable by one or more processors, the plurality of instructions when executed by the one or more processors cause the one or more processors to:
receive an identifier of an I/O interface, wherein the identifier is associated with an I/O card communicatively coupled with an industrial I/O interface bridge;
load a first interface driver of a processor system of the industrial I/O interface bridge, wherein the first interface driver is associated with the identifier;
generate a tunnel specific to the identifier between the industrial I/O interface bridge and a host computing system or gateway, wherein the tunnel utilizes the first interface driver of the processor system and a corresponding driver at the host computer system or gateway;
encapsulate data; and
transmit the encapsulated data from a sensor or an actuator to the host computing system or gateway, or vice versa from the host computing system or gateway to the sensor or the actuator, wherein the encapsulated data is transmitted via the tunnel between the industrial I/O interface bridge and host computing system or gateway, and wherein the encapsulated data is transmitted from or to the sensor or the actuator.

12. The non-transitory computer-readable storage medium of claim 11, wherein the first interface driver is associated with a USB driver.

13. The non-transitory computer-readable storage medium of claim 11, wherein the first interface driver is associated with a PCIe driver.

14. The non-transitory computer-readable storage medium of claim 11, wherein the processor system is a software implementation and programmable logic of the industrial I/O interface bridge is a hardware implementation, and wherein the processor system and the programmable logic are altered in combination to accept the I/O card transparently from a user.

15. The non-transitory computer-readable storage medium of claim 11, wherein the one or more processors are further to:
prior to loading the first interface driver of the processor system, reprogram programmable logic based on the identifier.

16. The industrial I/O interface bridge of claim 1, wherein the tunnel is generated using an abstraction process for connection tunneling to operate as if the I/O card is directly connected with the industrial I/O interface bridge.

17. The industrial I/O interface bridge of claim 1, wherein I/O card protocol traffic is tunneled between the host and the industrial I/O interface bridge over USB or PCIe standard host interfaces.

18. The industrial I/O interface bridge of claim 1, wherein the tunnel passes through an PCIe information technology (IT) interface.

19. The industrial I/O interface bridge of claim 1, wherein the first interface driver of the processor system is a custom class USB driver interfacing to I/O software drivers helping to fan-out data from a single physical USB interface to one or more I/O controllers.

20. The industrial I/O interface bridge of claim 1, wherein different class USB drivers are loaded for different I/O configurations.
